(19) United States
(12) Patent Application Publication
(10) Pub. No.: US 2005/0252958 A1
(43) Pub. Date: Nov. 17, 2005

(54) System and method for wireless transfer of data content to a portable device

(76) Inventor: Peter S. Lee, Calabasas Park, CA (US)

Correspondence Address: THE WALT DISNEY COMPANY;C/O GREENBERG TRAURIG LLP, 2450 COLORADO AVENUE SUITE 400E, SANTA MONICA, CA, 90404, US

(21) Appl. No.: 11/100,955

(22) Filed: Apr. 6, 2005

Related U.S. Application Data
(60) Provisional application No. 60/571,270, filed on May 13, 2004.

(51) Int. Cl. G06F 17/00

(52) U.S. Cl. 235/375

(57) ABSTRACT

A system and method for downloading content to a device adapted to play back the content including a portable media player having a data retaining memory storage device therein. A data receiver in the player receives data transmitted from a remote location and a wireless network interconnection is adapted to transmit data to the data receiver, the network having data content stored therein and incremented data content transmission means associated with the network for transmitting incremental portions of the data content to said portable media player, either sequentially or non-sequentially.

### RELATIONSHIP TO PRIOR APPLICATIONS

This application is a non-provisional application based on provisional application Ser. No. 60/571,270, filed May 13, 2004.

### BACKGROUND OF THE DISCLOSURE

1. Field of the Disclosure

The disclosure related to portable media players; and, more particularly, to wireless transfer of data content to a portable media player.

2. Related Art

Portable media players (PMP) are well known in the art. These players are usually pocket size devices that can store hundreds of movies, games or other media on a built-in hard drive and play the same back when desired. The media, games, photos or the like are stored on local storage, such as a built in hard drive, memory card, or other removable storage.

Data content providers download a wide variety of content to such players. Some content requires a substantially long period of time to be downloaded to obtain a complete media package, such as a full length movie.

There is a need for a system for wireless transfer of data content to a portable device, such as a portable media player.

### SUMMARY

It is an object of this disclosure to provide a system for the wireless transfer of data content to a portable media player in relatively small increments until the entire file is transferred.

Wireless technology is known for allowing a portable device, such as a portable media player, to access a remote database through a wireless internet connection, such as one in public places, such as airports, hotels and restaurants.

A wireless network transmits data between networks, or network computers, through radio waves rather than a data cable. A wireless system can transmit a signal to one's compatible notebook, desktop computer or other portable device, such as a portable media player. This can provide users access to a network at a remote location. Wireless networks offer cost-effective flexibility, allowing one to access a network from the road. (Range and speed will vary according to environmental and other factors.)

An access point is a communications device that transmits data via ratio waves to a portable device. Such an access point can of course be at a restaurant or any other location. Also, one must be within range of a wireless access point, or “hotspot,” and have an account with the wireless Internet Service Provider (“ISP”) that provides the network or a free ISP service available at a venue for use by the public.

Reception will depend on a variety of factors, including how far away the portable media player is from the access point.

One such wireless system is known as Bluetooth. Bluetooth transmits data between devices such as cellular phones, PDAs and notebook or desktop computers through short-range radio waves. Bluetooth radio waves reach a relatively short distance (less than 100 feet), and can transmit data from the device to a Personal Area Network (PAN).

Wireless technology can provide users with the same type of security that exists on wired networks when used in conjunction with existing network security technology. Such technology can ensure that only authorized users can access the information.

### DESCRIPTION OF THE PREFERRED EMBODIMENT

A portable media player is one which is adapted to store and playback various media that may be downloaded after purchase, or purchased by subscription or the like, such as:
1. Personal video content;
2. Media company content, including, but not limited to, movies, broadcast content, trailers, etc.;
3. Music;
4. Voice recordings;
5. Photos and other images;
6. Data in general.

Portable media devices can be used to download media utilizing known access points, such as at a public area, as a restaurant or the like. Providers of such media data can work with a restaurant, for example, to have a promotional program where media may be downloaded wirelessly onto the portable media player.

Certain media requires a rather long time to download. Thus, as particularly contemplated in the present disclosure, a movie or other media requiring a long download time is downloaded to a portable device, such as a portable media player, in small parts over a period of time. The media is downloaded in a trickle-down distribution until the entire media, such as a movie, is downloaded. One way to accomplish this to use the aforementioned wireless local are a networking systems, such as Wi Fi or any other suitable wireless internet access system. Such media may be available at one or more locations so that a user could go between access points, e.g., a restaurant, a theater, a video store, etc. picking up small parts of the media, such as a movie, until the entire movie is downloaded. Of course, other media, such as a game or the like, may be downloaded in small increments in like manner until the entire game is downloaded. Promotional spots related to both the source and the media provider may be downloaded. The downloading may be tied to a purchase by the owner of the portable media player of a meal or the like offered at the access point, such as a restaurant. For example, each time the owner of the portable media player visits the restaurant, and purchases a predetermined meal or other food item offered at the restaurant, the owner's purchase is recorded with the media database provider and the owner can now download another sequential segment of the data, such as a movie. This sequential downloading in small parts can be done automatically at the access point, or initiated by the user at home through an internet connection. It is not dependent on an access point at only one location, but could involve a number of locations.

It can be seen that the downloading of small sections or parts of content can be spread out over a long period of time, e.g., 5 days. Each time a different part of the content, such as a movie, is downloaded, until the entire movie is accumulated. Thus, as a promotional program with a venue, such as McDonald's® restaurant, a video, video game, new character for a game, etc., can be sent to the portable media player through a wireless internet connection, such as Wi Fi, as an alternative to giving out toys with Happy Meals or some other promotion. The foregoing may be accomplished each time the player is within range of a Wi Fi or other wireless access point. The reward for eating at a restaurant, for example, could be the automatic downloading of a segment of a movie or the like, or a short animated clip or cartoon.

There thus is disclosed the wireless transfer of data content to a portable media player in short segments over a period of time until the entire data content is downloaded.

The system disclosed herein downloads content to a device adapted to play back the content, the device including a portable media player having a data retaining memory storage device therein and a data receiver for receiving data transmitted from a remote location. A wireless network interconnection is adapted to transmit data to the data receiver, the network having data content stored therein and incremented data content transmission means associated with the network for transmitting incremental portions of the data content to the portable media player.

The data content may be a movie of a predetermined length and the transmission means may include means therein for transmitting the incremental portions to the player sequentially or non-sequentially over a predetermined period of time until the entire movie is downloaded to the player. Thus, a file can be delivered over a wireless network to the player and it is irrelevant which portion of the file arrives first. The cache built into the player will store whatever part of a file it receives. Once the player is docked or in range of another player or even a computer, the users player can share the parts of the file it has with other approved devices. This can be accomplished even if the player has all parts of the file or not.

The data content may be a game of a predetermined length and the transmission means may include means for transmitting the incremental portions sequentially or non-sequentially over a predetermined period of time until the entire game is downloaded to the player.

The data content may be a musical work of a predetermined length and the transmission means may include means for transmitting the incremental portions sequentially or a non-sequentially over a predetermined period of time until the entire musical work is downloaded to the player.

The data retaining memory storage device may be removable from the player and a flash card, memory stick or memory card.

The wireless network interconnection may include an access point available to the public at a venue.

Although a particular embodiment of the disclosure is disclosed, variations thereof may occur to an artisan and the scope of the disclosure should only be limited by the scope of the appended claims.

1. A system for downloading content to a device adapted to play back said content comprising:
a portable media player having a data retaining memory storage device therein and a data receiver in said player for receiving data transmitted from a remote location; and
a wireless network interconnection adapted to transmit data to said data receiver, said network having data content stored therein and incremented data content transmission means associated with said network for transmitting incremental portions of said data content to said portable media player.

2. The system of claim 1 wherein said data content is a movie of a predetermined length and said transmission means includes means therein for transmitting said incremental portions to said player either non-sequentially or sequentially over a predetermined period of time until the entire movie is downloaded to said player.

3. The system of claim 1 wherein said data content is a game of a predetermined length and said transmission means includes means therein for transmitting said incremental portions either non-sequentially or sequentially over a predetermined period of time until the entire game is downloaded to said player.

4. The system of claim 1 wherein said data content is a musical work of a predetermined length and said transmission means includes means for transmitting said incremental portions either non-sequentially or sequentially over a predetermined period of time until the entire musical work is downloaded to said player.

5. The system of claim 1 wherein said data retaining memory storage device is removable from said player.

6. The system of claim 5 wherein said memory storage device is a flash card.

7. The system of claim 5 wherever said memory storage device is a memory stick.

8. The system of claim 5 wherein said memory storage device is a memory card.

9. The system of claim 1 wherein said wireless network interconnection includes an access point available to the public at a venue.

10. A method for downloading content of a predetermined length to a portable media player comprising the steps of:
establishing a wireless access point connected to a wireless network at a venue adapted to transmit data to said player; and
transmitting an incremental part of said content to said player when said player is in wireless communication with said network.

11. The method of claim 10 including the step of transmitting other incremental parts of said content sequentially to said player over a predetermined period of time until the entire content is transmitted.

12. The method of claim 10 including the step of transmitting other incremental parts of said content non-sequentially to said player over a predetermined period of time until the entire content is transmitted.

13. The method of claim 10 wherein the step of downloading content includes the step of downloading a movie of a predetermined length.

14. The method of claim 11 wherein the step of downloading content includes the step of downloading a movie of a predetermined length.

15. The method of claim 10 wherein the step of downloading content includes the step of downloading a musical composition of a predetermined length.

16. The method of claim 11 wherein the step of downloading content includes the step of downloading a musical composition of a predetermined length.

17. The method of claim 10 wherein the step of transmitting an incremental part of said content includes the step of tying said transmission to a promotion at a venue whereby said part is transmitted when the owner of said player fulfills a requirement of said promotion.

18. The method of claim 17 including the step of non-sequentially transmitting more of said parts over a period of time when the owner of said player fulfills further requirements of said promotion.

19. The method of claim 12 including the step of non-sequentially transmitting more of said parts over a period of time from different wireless access points.

20. The method of claim 11 including the step of sequentially transmitting more of said parts over a period of time from different wireless access points.

21. The method of claim 12 including the step of non-sequentially transmitting more of said parts over a period of time from different wireless access points.
